(19) United States
(12) Patent Application Publication
(10) Pub. No.: US 2015/0279278 A1
(43) Pub. Date: Oct. 1, 2015

(54) DISPLAY DEVICE

(71) Applicant: SAMSUNG DISPLAY CO., LTD., Yongin-City (KR)

(72) Inventors: Kyong Tae Park, Suwon-si (KR); Pil Soo Ahn, Hwaseong-si (KR)

(21) Appl. No.: 14/488,245

(22) Filed: Sep. 16, 2014

(30) Foreign Application Priority Data
Mar. 26, 2014 (KR) 10-2014-0035354

(51) Int. Cl. G09G 3/32

(52) U.S. Cl. CPC G09G 3/3258; G09G 3/3291; G09G 2300/0866; G09G 2320/0223; G09G 2320/0238

(57) ABSTRACT

A display device includes: a first sub-pixel and a second sub-pixel, wherein the first sub-pixel includes: a first light emitting diode coupled between a first node and a second node; a first transistor configured to turn off the first light emitting diode by lowering a voltage of the first node below a voltage of the second node by providing a first initialization voltage to the first node; and a second transistor configured to turn on the first light emitting diode by increasing the voltage of the first node above the voltage of the second node by providing a first driving current to the first node, wherein the second sub-pixel includes a second light emitting diode, wherein a capacitance of the first light emitting diode is higher than a capacitance of the second light emitting diode.

### CROSS-REFERENCE TO RELATED APPLICATION

This application claims priority to and the benefit of Korean Patent Application No. 10-2014-0035354, filed on Mar. 26, 2014 in the Korean Intellectual Property Office, the disclosure of which is incorporated herein in its entirety by reference.

### BACKGROUND

1. Field

The present invention relates to a display device.

2. Description of the Related Art

A display device is a device that visually displays data. Display devices may be, for example, liquid crystal displays, electrophoretic displays, organic light emitting displays, inorganic EL (Electro Luminescent) displays, field emission displays, surface-conduction electron-emitter displays, plasma displays, or cathode ray displays.

Among them, the organic light emitting display is a display device that displays information, such as an image or text, using light that is generated through combination of holes and electrons, which are respectively provided from an anode electrode and a cathode electrode, in an organic layer that is positioned between the anode electrode and the cathode electrode.

The organic light emitting display includes a plurality of pixels having light emitting diodes, which are self-luminous devices, and each pixel includes a plurality of thin film transistors and capacitors formed therein to drive the light emitting diodes. The light emitting diode that is formed in each pixel has capacitance.

However, light emitting diodes of R, G, and B pixels have different capacitance levels, and in particular, the capacitance value of a light emitting diode of a G pixel is larger than the capacitance values of light emitting diodes of R and B pixels. Due to such a difference in capacitance between the light emitting diodes of the R, G, and B pixels, purple may be visually recognized at low gradation having a low driving current level.

### SUMMARY

Aspects of embodiments of the present invention include a display device, which may prevent color blurring at low gradation.

Aspects of embodiments of the present invention include a display device, which may stably display an image that corresponds to black data.

Additional characteristics, aspects, and features of the invention will be set forth in part in the description that follows and in part will become apparent to those having ordinary skill in the art upon examination of the following or may be learned from practice of the invention.

According to aspects of embodiments of the present invention, a display device includes: a pixel including a first sub-pixel and a second sub-pixel, wherein the first sub-pixel includes: a first light emitting diode coupled between a first node and a second node; a first transistor configured to turn off the first light emitting diode by lowering a voltage of the first node below a voltage of the second node by providing a first initialization voltage to the first node; and a second transistor configured to turn on the first light emitting diode by increasing the voltage of the first node above the voltage of the second node by providing a first driving current to the first node, wherein the second sub-pixel includes a second light emitting diode, wherein a capacitance of the first light emitting diode is higher than a capacitance of the second light emitting diode, and an area of a gate electrode of the first transistor is smaller than an area of a gate electrode of the second transistor.

A capacitance of the first transistor may be higher than a capacitance of the second transistor.

The area of the gate electrode of the first transistor may include a region where an electrode of the first transistor that is coupled to the first node and the gate electrode of the first transistor overlap each other, and the area of the gate electrode of the second transistor may include a region where an electrode of the second transistor that is coupled to the first node and the gate electrode of the second transistor overlap each other.

The first transistor may be configured to turn off the first light emitting diode by providing the first initialization voltage to the first node in response to a black scan signal, and the second transistor may be configured to turn on the first light emitting diode by providing the first driving current to the first node in response to a light emission signal.

The light emission signal and the black scan signal may have phases opposite to each other.

The second sub-pixel may include: the second light emitting diode coupled between a third node and a fourth node; a third transistor configured to turn off the second light emitting diode by lowering a voltage of the third node below a voltage of the fourth node by providing a second initialization voltage to the third node; and a fourth transistor configured to turn on the second light emitting diode by increasing the voltage of the third node above the voltage of the fourth node by providing a second driving current to the third node.

A level of the first initialization voltage may be equal to a level of the second initialization voltage.

A capacitance of the third transistor may be substantially equal to a capacitance of the fourth transistor.

According to aspects of embodiments of the present invention, a display device includes: a pixel including a first sub-pixel and a second sub-pixel, wherein the first sub-pixel includes: a first light emitting diode coupled between a first node and a second node; a first transistor configured to turn off the first light emitting diode by lowering a voltage of the first node below a voltage of the second node by providing of a first initialization voltage to the first node; and a second transistor configured to turn on the first light emitting diode by increasing the voltage of the first node above the voltage of the second node through by providing a first driving current to the first node, wherein the second sub-pixel includes a second light emitting diode, wherein a capacitance of the first light emitting diode is lower than a capacitance of the second light emitting diode, and wherein an area of a gate electrode of the first transistor is larger than an area of a gate electrode of the second transistor.

A capacitance of the first transistor may be lower than a capacitance of the second transistor.

The area of the gate electrode of the first transistor may include a region where an electrode of the first transistor that is coupled to the first node and the gate electrode of the first transistor overlap each other, and the area of the gate electrode of the second transistor may include a region where an electrode of the second transistor that is coupled to the first node and the gate electrode of the second transistor overlap each other.

The first transistor may be configured to turn off the first light emitting diode by providing the first initialization voltage to the first node in response to a black scan signal, and the second transistor may be configured to turn on the first light emitting diode by providing the first driving current to the first node in response to a light emission signal.

The light emission signal and the black scan signal may have phases opposite to each other.

The second sub-pixel may include: the second light emitting diode coupled between a third node and a fourth node; a third transistor configured to turn off the second light emitting diode by lowering a voltage of the third node below a voltage of the fourth node by providing a second initialization voltage to the third node; and a fourth transistor configured to turn on the second light emitting diode by increasing the voltage of the third node above the voltage of the fourth node by providing a second driving current to the third node.

A level of the first initialization voltage may be equal to a level of the second initialization voltage.

A capacitance of the third transistor may be substantially equal to a capacitance of the fourth transistor.

According to aspects of embodiments of the present invention, a display device includes: a pixel including a first sub-pixel and a second sub-pixel, wherein the first sub-pixel includes: a first light emitting diode coupled between a first node and a second node; a first transistor configured to turn off the first light emitting diode by lowering a voltage of the first node below a voltage of the second node by providing a first initialization voltage to the first node; and a second transistor configured to turn on the first light emitting diode by increasing the voltage of the first node above the voltage of the second node by providing a first driving current to the first node, wherein the second sub-pixel includes: a second light emitting diode coupled between a third node and a fourth node; a third transistor configured to turn off the second light emitting diode by lowering a voltage of the third node below a voltage of the fourth node by providing of a second initialization voltage to the third node; and a fourth transistor configured to turn on the second light emitting diode by increasing the voltage of the third node above the voltage of the fourth node by providing a second driving current to the third node, wherein a capacitance of the first light emitting diode is higher than a capacitance of the second light emitting diode, wherein an area of a gate electrode of the first transistor is smaller than an area of a gate electrode of the second transistor, and wherein an area of a gate electrode of the third transistor is larger than an area of a gate electrode of the fourth transistor.

A capacitance of the first transistor may be higher than a capacitance of the second transistor, and a capacitance of the third transistor may be lower than a capacitance of the fourth transistor.

The area of the gate electrode of the first transistor may include a region where an electrode of the first transistor that is coupled to the first node and the gate electrode of the first transistor overlap each other, the area of the gate electrode of the second transistor may include a region where an electrode of the second transistor that is coupled to the first node and the gate electrode of the second transistor overlap each other, the area of the gate electrode of the third transistor may include a region where an electrode of the third transistor that is coupled to the second node and the gate electrode of the third transistor overlap each other, and the area of the gate electrode of the fourth transistor may include an area of a region where an electrode of the fourth transistor that is coupled to the second node and the gate electrode of the fourth transistor overlap each other.

A level of the first initialization voltage may be equal to a level of the second initialization voltage.

The characteristics of the present invention are not limited to the contents as explained above, and additional characteristics are described below.

### BRIEF DESCRIPTION OF THE DRAWINGS

The above and other characteristics, features, and aspects of the present invention will be more apparent from the following detailed description taken in conjunction with the accompanying drawings, in which:

FIG. 1 is a block diagram of a display device according to embodiments of the present invention;

FIG. 2 is a block diagram of a driving unit according to embodiments of the present invention;

FIG. 3 is an equivalent circuit diagram of RGB pixels of a display device according to some embodiments of the present invention;

FIG. 4 is a layout diagram schematically illustrating positions of thin film transistors and capacitors of RGB pixels of a display device according to some embodiments of the present invention;

FIG. 5 is a layout diagram illustrating one pixel of FIG. 4;

FIG. 6 is a cross-sectional view cut along the lines VIa-VIa′ and VIb-VIb′ of FIG. 5;

FIG. 7 is a timing diagram illustrating level changes of signals applied to a display device according to some embodiments of the present invention;

FIG. 8 is a graph illustrating level changes of current and voltage applied to light emitting diodes of a display device according to some embodiments of the present invention;

FIG. 9 is an equivalent circuit diagram of RGB pixels of a display device according to some embodiments of the present invention;

FIG. 10 is a layout diagram schematically illustrating positions of thin film transistors and capacitors of RGB pixels of a display device according to some embodiments of the present invention;

FIG. 11 is a cross-sectional view cut along the lines XIa-XIa′ and XIb-XIb′ of FIG. 10;

FIG. 12 is a graph illustrating level changes of current and voltage applied to light emitting diodes of a display device according to some embodiments of the present invention;

FIG. 13 is an equivalent circuit diagram of RGB pixels of a display device according to some embodiments of the present invention;

FIG. 14 is a layout diagram schematically illustrating positions of thin film transistors and capacitors of RGB pixels of a display device according to some embodiments of the present invention;

FIG. 15 is an equivalent circuit diagram of RGB pixels of a display device according to some embodiments of the present invention;

FIG. 16 is a layout diagram schematically illustrating positions of thin film transistors and capacitors of RGB pixels of a display device according to some embodiments of the present invention;

FIG. 17 is an equivalent circuit diagram of RGB pixels of a display device according to some embodiments of the present invention; and

FIG. 18 is a layout diagram schematically illustrating positions of thin film transistors and capacitors of RGB pixels of a display device according to some embodiments of the present invention.

### DETAILED DESCRIPTION

Aspects and features of the present invention and methods of accomplishing the same may be understood more readily by reference to the following detailed description of some embodiments and the accompanying drawings. The present invention may, however, be embodied in many different forms and should not be construed as being limited to the embodiments set forth herein. Rather, these embodiments are provided so that this disclosure will be more thorough and more complete and will convey concepts of the invention to those skilled in the art, and the present invention will be defined by the appended claims, and their equivalents.

With respect to some embodiments, well-known structures and devices are not shown in order to reduce repetitive description of the invention. Like numbers refer to like elements throughout. In the drawings, the thickness of layers and regions are exaggerated for clarity.

It will be understood that when an element or layer is referred to as being “on,” “connected to,” or “coupled to” another element or layer, it can be directly on, directly connected to, or directly coupled to the other element or layer, or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the invention. Accordingly, the example views may be modified depending on manufacturing technologies and/or tolerances. Therefore, the embodiments of the invention are not limited to those shown in the views, but include modifications in configuration formed on the basis of manufacturing processes. Therefore, regions illustrated in the figures have schematic properties and shapes of regions shown in the figures illustrate specific shapes of regions of elements and do not limit aspects of the invention.

Hereinafter, embodiments of the present invention will be described with reference to the attached drawings.

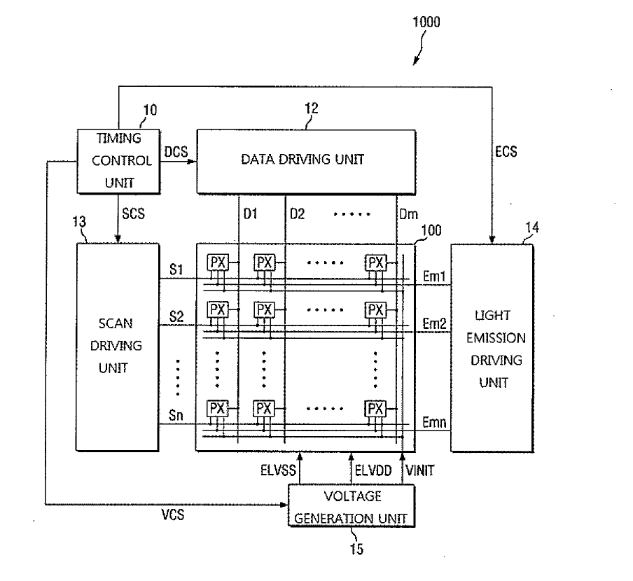

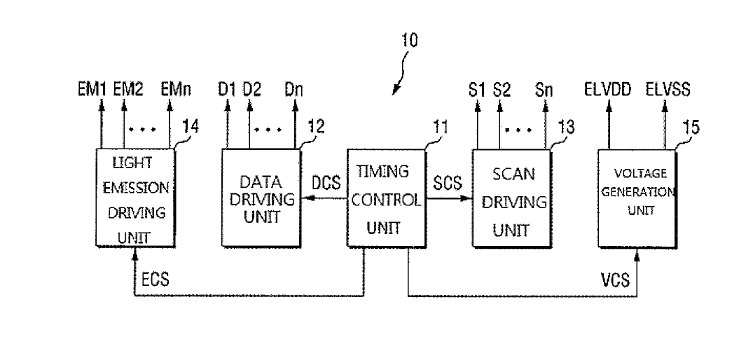

FIG. 1 is a block diagram of a display device according to some embodiments of the present invention, and FIG. 2 is a block diagram of a driving unit according to some embodiments of the present invention.

Referring to FIGS. 1 and 2, an organic light emitting display 1000 includes a display panel 100.

The display panel 100 may include a plurality of pixels PX and wirings for transferring signals to the plurality of pixels PX. The plurality of pixels PX may be arranged in the form of a matrix. Each of the plurality of pixels PX may emit light, for example, red, green, or blue light. Light emission of the plurality of pixels PX may be controlled by first to n-th scan signals S1 to Sn, first to m-th data signals D1 to Dm, and first to n-th light emission signals EM1 to EMn, which are provided from external source (e.g., the scan driving unit 13 and the data driving unit 12, respectively). The first to n-th scan signals S1 to Sn may control whether the plurality of pixels PX receive the first to m-th data signals D1 to Dm. The first to m-th data signals D1 to Dm may include information on luminance of light emitted by the plurality of pixels PX. The first to m-th light emission signals EM1 to EMn may control whether the plurality of pixels PX emit light.

The wirings may include wirings for transferring the first to n-th scan signals S1 to Sn, the first to m-th data signals D1 to Dm, the first to m-th light emission signals EM1 to EMn, and an initialization voltage VINT. The wirings for transferring the first to n-th scan signals S1 to Sn and the first to m-th light emission signals EM1 to EMn may be arranged to extend in a row direction of the plurality of pixels PX. The wirings for transferring the first to m-th data signals D1 to Dm may be arranged to extend in a column direction of the plurality of pixels PX. The wirings for transferring the initialization voltage VINT may be formed in a zigzag (e.g., alternating column and row directions) shape.

The organic light emitting display 100 may further include a driving unit and a power generation unit 15.

The driving unit may include a timing control unit 11, a data driving unit 12, a scan driving unit 13, and a light emission driving unit 14. The timing control unit 11 may receive video data from an outside, and may generate a scan driving unit control signal SCS that can control the scan driving unit 13, a date driving unit control signal DCS that can control the data driving unit 12, and a light emission driving unit control signal ECS that can control the light emission driving unit 14 in response to the received video data.

The data driving unit 12 may receive the data driving unit control signal DCS, and may generate the first to m-th data signals D1 to Dm in response to the received data driving unit control signal DCS.

The scan driving unit 13 may receive the scan driving unit control signal SCS, and may generate the first to n-th scan signals S1 to Sn in response to the received scan driving unit control signal SCS.

The light emission driving unit 14 may receive the light emission driving unit control signal ECS, and may generate the first to n-th light emission signals EM1 to EMn in response to the received light emission driving unit control signal ECS.

The power generation unit 15 may generate the initialization voltage VINT, a first power voltage ELVDD, and a second power voltage ELVSS to provide the generated voltages to the display panel 100. In some embodiments, the initialization voltage VINT, the first power voltage ELVDD, and the second power voltage ELVSS may be varied, and the timing control unit 11 may control the power generation unit 15 to vary the initialization voltage VINT, the first power voltage ELVDD, and the second power voltage ELVSS.

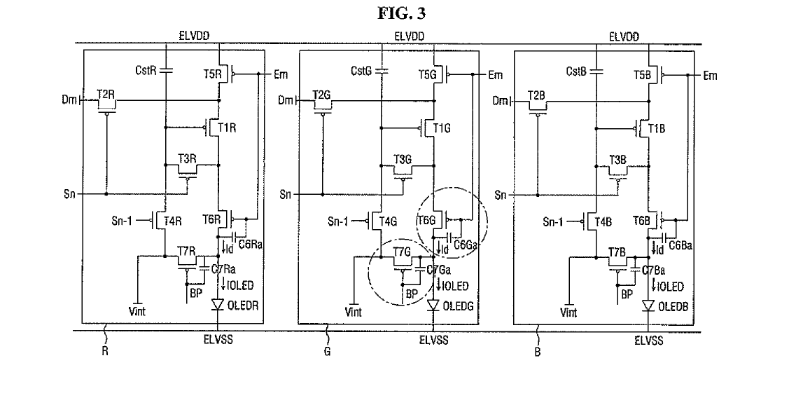

FIG. 3 is an equivalent circuit diagram of RGB pixels of a display device according to some embodiments of the present invention.

Referring to FIG. 3, a pixel of a display device according to an embodiment of the present invention may include a first sub-pixel, a second sub-pixel, and a third sub-pixel. The first sub-pixel may be, for example, an R pixel on which red video data is displayed. The second sub-pixel may be, for example, a G pixel on which green video data is displayed. The third sub-pixel may be, for example, a B pixel on which blue video data is displayed. FIG. 3 illustrates that the display device includes three sub-pixels, but is not limited thereto. The display device may include a plurality of sub-pixels.

Each of the first sub-pixel, the second sub-pixel, and the third sub-pixel may receive a plurality of signals Dm, Sn, Sn-1, Em, ELVDD, ELVSS, and VINT, and may include a plurality of thin film transistors T1 to T7, a storage capacitor Cst, and a light emitting diode OLED.

In this embodiment, the second sub-pixel, for example, a G pixel (e.g., configured to emit a green-colored light), may include a light emitting diode OLED_G of the second sub-pixel that is coupled between a second node N2 and a terminal of the second power voltage ELVSS, a seventh transistor T7Ga of the second sub-pixel that turns off the light emitting diode OLED_G of the second sub-pixel by lowering the voltage of the second node N2 below the second power voltage ELVSS, and a sixth transistor T6Ga of the second sub-pixel that turns on the light emitting diode OLED_G of the second sub-pixel by increasing the voltage of the second node N2 above the second power voltage ELVSS.

The third sub-pixel, for example, B pixel (e.g., configured to emit a blue-colored light), may include a light emitting diode OLED_B of the third sub-pixel that is coupled between a third node N3 and a terminal of the second power voltage ELVSS, a seventh transistor T7Ba of the third sub-pixel that turns off the light emitting diode OLED_B of the third sub-pixel by lowering of the voltage of the third node N3 below the second power voltage ELVSS, and a sixth transistor T6Ba of the third sub-pixel that turns on the light emitting diode OLED_B of the third sub-pixel by increasing the voltage of the third node N3 above the second power voltage ELVSS.

The capacitance Coled_G of the light emitting diode of the second sub-pixel may be higher than the capacitance Coled_B of the light emitting diode of the third sub-pixel. If the light emitting diode has a high capacitance, the amount of time to charge the light emitting diode to turn on may be correspondingly high, compared to a light emitting diode with a lower capacitance. Accordingly, at low gradation, the light emitting diode OLED_G of the second sub-pixel, for example, the pixel that displays a green image, may not emit light. That is, only the light emitting diodes OLED_R and OLED_B of the pixels that display blue and red images emit light, and thus a phenomenon that the color purple is visually perceived may occur.

In order to prevent (or reduce or substantially prevent) the color purple from being visually perceived, the charging speed of the light emitting diode OLED_G of the second sub-pixel may be increased. In order to increase the charging speed of the light emitting diode OLED_G of the second sub-pixel, the level of the initialization voltage VINT that is applied to the light emitting diode OLED_G of the second sub-pixel may be increased. However, adjusting only the level of the initialization voltage VINT that is applied to the light emitting diode OLED_G of the second sub-pixel may increase complexity during manufacturing. Accordingly, the charging speed of the light emitting diode OLED_G of the second sub-pixel may be increased by adjusting the capacitance C7Ga of the seventh transistor of the second sub-pixel and the capacitance C6Ga of the sixth transistor of the second sub-pixel.

Each of the first sub-pixel R, the second sub-pixel G, and the third sub-pixel B may include the first transistor T1, the second transistor T2, the third transistor T3, the fourth transistor T4, the fifth transistor T5, the sixth transistor T6, and the seventh transistor T7.

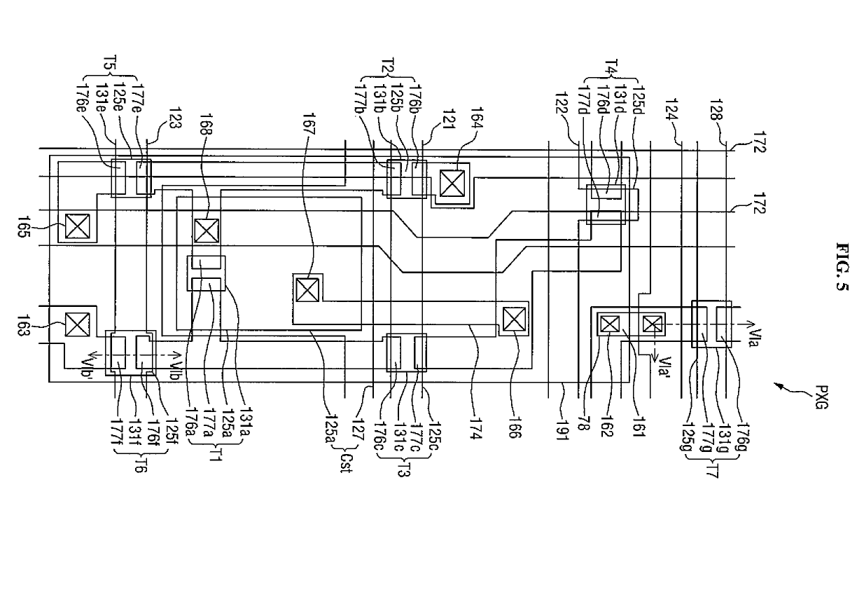

The first transistor T1 may operate as a driving transistor. The gate electrode 125 (in FIG. 5) of the first transistor T1 is coupled to one end of the storage capacitor Cst, and the source electrode of the first transistor T1 is coupled to the first power voltage ELVDD via the fifth transistor T5. The drain electrode of the first transistor T1 is electrically coupled to the anode electrode of the light emitting diode OLED via the sixth transistor T6. In accordance with the switching operation of the second transistor T2, the first transistor T1 may receive a data signal DM and may supply a driving current Id to the light emitting diode OLED. The level of current that flows to the light emitting diode OLED may correspond to the electric potential difference Vgs between the source electrode and the gate electrode of the driving transistor Td.

The gate electrode of the second transistor T2 is coupled to the scan line 121 (in FIG. 5), and the source electrode of the second transistor T2 is coupled to the data line 171 (in FIG. 5). The drain electrode of the second transistor T2 is coupled to the source electrode of the first transistor T1 and may be coupled to the first power voltage ELVDD via the fifth thin film transistor T5. The second transistor T2 is turned on according to the scan signal that is transferred through the scan line 121 (in FIG. 5), and performs switching operation to transfer the data signal DM that is transferred through the data line Dm to the source electrode of the first transistor T1.

The gate electrode of the third transistor T3 is coupled to the scan line 121 (in FIG. 5), and the source electrode of the third transistor T3 is coupled to the drain electrode of the first transistor T1 and is also coupled to the anode electrode of the light emitting diode OLED via the sixth transistor T6. The drain electrode of the third transistor T3 is coupled to one end of the storage capacitor Cst, the drain electrode of the fourth transistor T4, and the gate electrode of the first transistor T1. The third transistor T3 is turned on according to the scan signal that is transferred through the scan line 121 (in FIG. 5), and couples the gate electrode and the drain electrode of the first transistor T1 to each other to perform diode-coupling of the first transistor T1.

The gate electrode of the fourth transistor T4 is coupled to the previous scan light 122 (in FIG. 5), and the source electrode of the fourth transistor T4 is coupled to the initialization voltage VINT. The drain electrode of the fourth transistor T4 is coupled to one end of the storage capacitor Cst, the drain electrode of the third transistor T3, and the gate electrode of the first transistor T1. The fourth transistor T4 is turned on according to the previous scan signal that is transferred through the previous scan line 122 (in FIG. 5), and performs the initialization operation to initialize the voltage of the gate electrode 125 (in FIG. 5) of the first transistor T1 through transfer of the initialization voltage VINT to the gate electrode of the first transistor T1.

The gate electrode of the fifth transistor T5 is coupled to the light emission control line 123 (in FIG. 5), and the source electrode of the fifth transistor T5 is coupled to the first power voltage ELVDD. The drain electrode of the fifth transistor T5 is coupled to the source electrode of the first transistor T1 and the drain electrode of the second transistor T2.

The gate electrode of the sixth transistor T6 is coupled to the light emission control line 123 (in FIG. 5), and the source electrode of the sixth transistor T6 is coupled to the drain electrode of the first transistor T1 and the source electrode of the third transistor T3. The drain electrode of the sixth transistor T6 may be electrically coupled to the anode electrode of the light emitting diode OLED. The fifth transistor T5 and the sixth transistor T6 as described above are concurrently (or simultaneously) turned on according to the light emission control signal that is transferred through the light emission control line 123 (in FIG. 5), and transfer the first power voltage ELVDD to the light emitting diode OLED to make the driving current Id flow to the light emitting diode OLED. The sixth transistor T6 may have capacitance C6Ra, C6Ga, and C6Ba.

The gate electrode of the seventh transistor T7 is coupled to a black signal line 128 (in FIG. 5), and the source electrode of the seventh transistor T7 is coupled to the drain electrode of the sixth transistor T6 and the anode electrode of the light emitting diode OLED. The drain electrode of the seventh transistor T7 is coupled to the initialization voltage VINT and the source electrode of the fourth transistor T4. The seventh transistor T7 may have capacitance C7Ra, C7Ga, and C7Ba.

The seventh transistor T7 receives a black scan signal BS from the black signal line 128 (in FIG. 5). The black scan signal Bs is a voltage (e.g., of a predetermined level) that can always turn off the seventh transistor T7. As the voltage of the transistor-off level is transferred to the gate electrode of the seventh transistor T7, the seventh transistor T7 is always turned off, and in this state, a part of the driving current Id goes out through the seventh transistor T7.

If the light emitting diode OLED emits light even in the case where minimum current of the first transistor T1 that displays a black image flows as the driving current, the black image may not be properly displayed. Accordingly, the seventh transistor T7 of the light emitting display according to an embodiment of the present invention may disperse a part of the minimum current of the first transistor T1 to other current paths except for a current path toward the light emitting diode. Here, the minimum current of the first transistor means current on condition that the gate-source voltage Vgs of the first transistor T1 is lower than a threshold voltage Vth and thus the first transistor T1 is turned off. The minimum driving current on condition that the first transistor T1 is turned off is transferred to the light emitting diode to be expressed as an image of black luminance.

If the minimum driving current that displays the black image flows, the roundabout transfer exerts a great influence, while if high driving current that displays a general image or an image, such as a white image, flows, the roundabout current exerts almost no influence. Accordingly, in the case where the driving current that displays the black image flows, the light emission current loled of the light emitting diode, which is decreased as much as the current amount of the roundabout current that goes out through the seventh transistor T7 from the driving current Id may have the minimum current amount to the extent that the black image is clearly expressed. Accordingly, the contrast ratio may be improved through implementation of an image of accurate black luminance using the seventh transistor T7.

The capacitance C6Ga of the sixth transistor of the second sub-pixel and the capacitance C7Ga of the seventh transistor of the second sub-pixel may differ depending on the area of the gate electrode of the sixth transistor of the second sub-pixel and the area of the gate electrode of the seventh transistor of the second sub-pixel. The capacitance of the transistor is in reverse proportion to the area of the transistor. Further, the area of the gate electrode includes the area of the gate electrode, but is not limited thereto. The area of the gate electrode may further include the overlapping area between the gate electrode and the drain electrode or between the gate electrode and the source electrode.

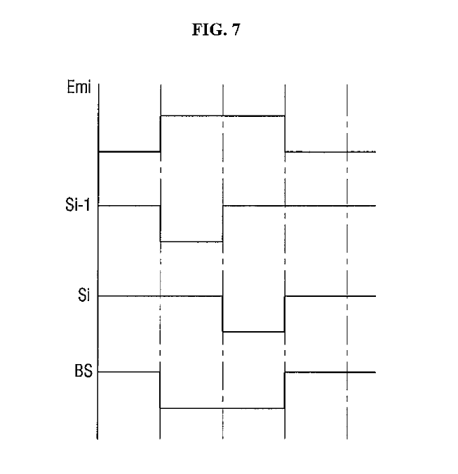

Hereinafter, referring to FIG. 7, the concrete operation of one pixel of a light emitting display according to an embodiment of the present invention will be described in detail.

First, a previous scan signal of a low level is supplied through the previous scan line 121 (in FIG. 5) during an initialization period. In this case, the fourth transistor T4 is turned on in response to the previous scan signal of a low level, and the initialization voltage VINT is coupled to the gate electrode of the first transistor T1 through the fourth transistor T4 to initialize the first transistor T1.

Thereafter, a scan signal Sn of a low level is supplied through the scan line during a data programming period. In this case, the second transistor T2 and the third transistor T3 are turned on in response to the scan signal Sn of a low level. At this time, the first transistor T1 is diode-coupled by the third transistor T3 that is in a turned-on state to be forward biased.

Then, a compensation voltage Dm+Vth (where, Vth has a negative (−) value), which is decreased as much as the threshold voltage Vth of the first transistor T1 from the data signal DM supplied from the data line Dm, is applied to the gate electrode of the first transistor T1.

The driving voltage ELVDD and the compensation voltage Dm+Vth are applied to both ends of the storage capacitor Cst, and charge that corresponds to the voltage difference between both ends of the storage capacitor Cst is stored in the storage capacitor Cst. Thereafter, the light emission control signal that is supplied from the light emission control line Emn during the light emission period is changed from high level to low level. Thus, the fifth transistor T5 and the sixth transistor T6 may be turned on by the low-level light emission control signal during the light emission period.

Then, the driving current Id is generated according to the voltage difference between the voltage of the gate electrode of the first transistor T1 and the first power voltage ELVDD, and the driving current Id is supplied to the light emitting diode OLED through the sixth transistor T6. During the light emission period, the gate-source voltage Vgs of the first transistor T1 is kept (Dm+Vth)-ELVDD by the storage capacitor Cst, and according to the current-voltage relationship of the first transistor T1, the driving current Id is in proportion to a square of a value that is obtained by subtracting the threshold voltage from the source-gate voltage. Accordingly, the driving current Id is determined regardless of the threshold voltage Vth of the first transistor T1.

The light emission scan signal Emi supplies a high-level signal while the previous scan signal Sn-1 and the scan signal Sn successively supply low-level signals. That is, the fifth and sixth transistors T5 and T6 are turned off while the second to fourth transistors T2 to T4 are turned on by the previous scan signal Sn-1 and the scan signal Sn.

The black scan signal BS has a phase that is opposite to the phase of the light emission signal Emi. While the light emission signal Emi is at high level, the black scan signal BS applies a low-level signal so that the initialization voltage VINT is applied to the anode of the light emitting diode OLED.

The configuration of an organic light emitting display according to the present invention may not be limited to the circuit of the organic light emitting display illustrated in FIG. 3 according to an embodiment of the present invention.

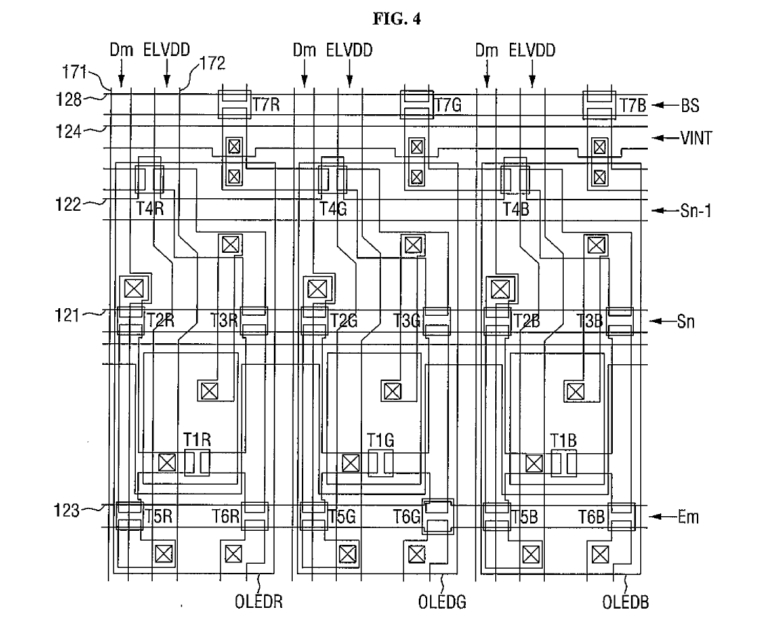

Hereinafter, referring to FIGS. 4 and 5, some of the structure of a pixel of a display device according to some embodiments of the present invention will be described.

FIG. 4 is a layout diagram schematically illustrating positions of thin film transistors and capacitors of RGB pixels of a display device according to some embodiments of the present invention.

Referring to FIG. 4, a pixel of an organic light emitting display according to some embodiments of the present invention may include a first sub-pixel R, a second sub-pixel G, and a third sub-pixel B. Further, each sub-pixel may receive a scan signal Sn, a previous scan signal Sn-1, a light emission control signal Em, an initialization voltage VINT, and a black signal Bs. Further, the sub-pixel may include a scan line 121 (in FIG. 5), a previous scan line 122 (in FIG. 5), a light emission control line 123 (in FIG. 5), an initialization voltage line 124 (in FIG. 5), and a black signal line 128 (in FIG. 5), which are formed along a row direction, and may also include a data line 171 and a driving voltage line 172, which cross the scan line 121 (in FIG. 5), the previous scan line 122 (in FIG. 5), the light emission control line 123 (in FIG. 5), and the initialization voltage line 124 (in FIG. 5), and apply a data signal Dm and a driving voltage ELVDD to the pixel.

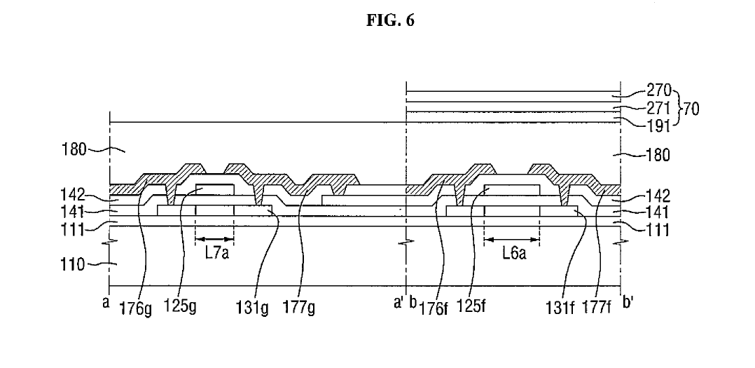

Further, each sub-pixel may include a first transistor T1, a second transistor T2, a third transistor T3, a fourth transistor T4, a fifth transistor T5, a sixth transistor T6, a seventh transistor T7, a storage capacitor Cst, and a light emitting diode OLED (70 in FIG. 6).

The first transistor T1, the second transistor T2, the third transistor T3, the fourth transistor T4, the fifth transistor T5, the sixth transistor T6, and the seventh transistor T7 may be formed along a semiconductor layer 131 (in FIG. 5). The semiconductor layer 131 is made of a suitable semiconductor material such as polysilicon, and may include a channel region doped with no impurity, a source region and a drain region, which are formed on both sides of the channel region and are doped with impurities. Here, such impurities may differ depending on the kind of thin film transistor, and may include an N-type impurity and a P-type impurity. The semiconductor layer may include a first semiconductor layer 131a formed on the first transistor T1, a second semiconductor layer 131b formed on the second transistor T2, a third semiconductor layer 131c formed on the third transistor T3, a fourth semiconductor layer 131d formed on the fourth transistor T4, a fifth semiconductor layer 131e formed on the fifth transistor T5, a sixth semiconductor layer 131f formed on the sixth transistor T6, and a seventh semiconductor layer 131g formed on the seventh transistor T7.

FIG. 5 illustrates that the sixth semiconductor layer 131f formed on the sixth transistor T6G of the second sub-pixel is formed with a larger size than the size of the semiconductor layer 131 of any other transistor of the second sub-pixel G. In FIG. 4, the area of the gate electrode of the sixth transistor T6G of the first sub-pixel is modified. However, the modification of the area of the gate electrode is not limited thereto, and all the areas of the gate electrodes of the seventh transistor T7G, the sixth transistor T6G, and the seventh transistor T7G of the second sub-pixel may be modified.

Because the internal capacitance Coled of the light emitting diode OLED_G of the second sub-pixel is higher than the internal capacitance of the light emitting diode of any other sub-pixel, the voltage level of the first node N1 may be compensated for through adjustment of the capacitance of the sixth transistor T6 and the seventh transistor T7.

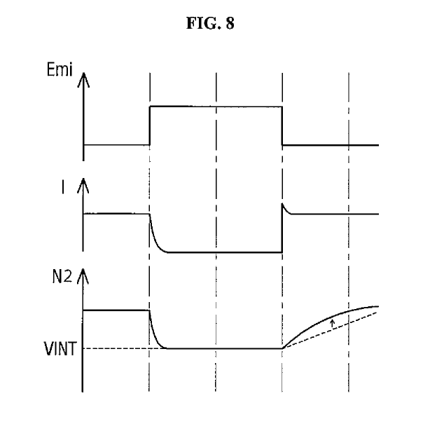

Whether the light emitting diode OLED of the sub-pixel having different internal capacitance Coled can be compensated for may be known through calculation of the voltage level of the first node NI to which the anode of the light emitting diode OLED is coupled. Hereinafter, referring to FIG. 8, the change of the voltage level of the first node NI of the light emitting diode OLED and the current level of the first node N1 will be described in detail.

FIG. 8 is a graph illustrating level changes of current and voltage applied to light emitting diodes of a second sub-pixel of a display device according to an embodiment of the present invention.

During a period in which the light emission signal Emi has low level, the voltage of the second node N2 may be kept a level that is equal to or higher than the light emission absolute potential of the light emitting diode OLED_G. Further, the current loled that flows to the light emitting diode OLED_G may also be kept constant.

At the moment when the light emission signal Emi is changed to a high level, the black scan signal BS also falls to a low level, and the voltage of the second node N2 abruptly falls to the initialization voltage VINT. Further, the current I that flows to the light emitting diode OLED_G is also decreased in a similar manner to the voltage of the second node N2.

At the moment when the light emission signal Emi falls again to a low level, the black scan signal BS rises to a high level. Because the black scan signal BS of a high level is applied, the seventh transistor T7 is turned off, and the initialization voltage VINT is not provided to the second node N2. The sixth transistor T6G is turned on by the light emission signal Emi, and the driving current Id_G, of which the level is equal to or higher than the level of the light emission absolute potential of the light emitting diode OLED_G, is applied to the second node N2. However, coupling may occur due to the internal capacitance of the light emitting diode OLED_G, the sixth transistor, and the seventh transistor. At the moment when the coupling occurs, the level of the current I abruptly rises, but falls soon to a stable level. The voltage of the second node N2 at the moment when the coupling occurs may rise or fall according to the capacitance C6Ga of the sixth transistor and the capacitance C7Ga of the seventh transistor. The voltage level of the second node N2 can be calculated to follow Equation 1 below.

$$VN 2 = \frac{1}{Coled} {\int }_{0}^{1 H} ileak ( t ) d t + VINT + ( \frac{0.5 {C}_{7}}{Coled + 0.5 {C}_{7}} - \frac{0.5 {C}_{6}}{Coled + 0.5 {C}_{6}} ) \times ( VGH - VGL ) \\ VN 1 = \frac{1}{Coled} {\int }_{0}^{1 H} ileak ( t ) d t + VINT + ( \frac{0.5 {C}_{7}}{Coled + 0.5 {C}_{7}} - \frac{0.5 {C}_{6}}{Coled + 0.5 {C}_{6}} ) \times ( VGH - VGL ) \qquad Equation 1$$

The first term of Equation 1 means the voltage change of the second node N2 by leakage current. The second term of Equation 1 means the voltage change of the second node N2 when the initialization voltage VINT is applied. The last item of Equation 1 means the voltage change of the second node N2 by coupling of the light emitting diode, the sixth transistor, and the seventh transistor.

The first item of Equation 1 means that the voltage of the second node N2 may rise by the leakage current ileak that may be generated although a signal to turn on the sixth transistor is not applied.

The second item of Equation 1 means that the second node N2 may have a voltage having the same level as the level of the initialization voltage VINT when the seventh transistor is turned on and the initialization voltage VINT is applied to the second node N2. When the seventh transistor is turned off, the voltage of the second node N2 may rise or fall due to the influence of other items except for the second term.

The last item of Equation 1 means the voltage of the second node N2 that is coupled by the internal capacitance of the light emitting diode, the sixth transistor, and the seventh transistor. The level of the voltage change due to the coupling may be in proportion to a swing width of the voltage that is applied to the gate electrode of each transistor. Further, the voltage change due to the coupling may have a positive value or a negative value depending on the levels of the capacitance C6 of the sixth transistor and the capacitance C7 of the seventh transistor.

In arrangement of Equation 1, if the level of the capacitance C7 of the seventh transistor is higher than the level of the capacitance C6 of the sixth transistor, the last term of Equation 1 has a positive value, and thus the voltage of the second node N2 can be heightened. Accordingly, it becomes possible to make the light emitting diode OLED emit light rapidly without adjusting the value of the initialization voltage VINT.

Further, if the level of the capacitance C7 of the seventh transistor is lower than the level of the capacitance C6 of the sixth transistor, the last term of Equation 1 has a negative value, and thus the voltage of the second node N2 can be lowered. Accordingly, the voltage of the second node N2 may be lower than the light emission absolute potential of the light emitting diode OLED without adjusting the value of the initialization voltage VINT. The light emission absolute potential means a voltage that is obtained by summing the second power voltage ELVSS and the threshold voltage of the light emitting diode OLED. If the voltage of the second node N2 is lower than the light emission absolute potential, the light emitting diode is turned off to emit no light.

Referring again to FIG. 4, the area of the gate electrode of the sixth transistor of the second sub-pixel is larger than the area of the gate electrode of the second transistor of the second sub-pixel. Accordingly, the capacitance C6Ga of the sixth transistor of the second sub-pixel is lower than the capacitance C7Ga of the seventh transistor of the second sub-pixel. Accordingly, the voltage of the first node N1 is higher than the initialization voltage VINT due to the coupling effect, and thus can make the light emitting diode OLED_G emit light rapidly. This can be confirmed through the voltage level graph at the first node N1 in FIG. 8.

Hereinafter, referring to FIG. 5, the structure of a G pixel of a display device according to an embodiment of the present invention will be described.

Referring to FIG. 5, the first transistor T1 includes a first semiconductor layer 131a, a first gate electrode 125a, a first source electrode 176a, and a second drain electrode 177a. The first semiconductor layer 131a may be formed to be bent. The storage capacitor Cst may be formed on the first gate electrode 125a to overlap the first gate electrode 125a. The storage capacitor Cst may include a first storage capacitive plate 125a and a second storage capacitive plate 127, which are arranged so that a second gate insulating layer 142 is interposed between the capacitive plates 125a and 127. Here, the first gate electrode 125a also serves as the first storage capacitive plate 125a, and the second gate insulating layer is made of a dielectric material. The storage capacitance may be determined by the charge stored in the storage capacitor Cst and the voltage between the capacitive plates 125a and 127.

The first storage capacitive plate 125a may be formed to be separated from an adjacent pixel in a rectangular shape, and may be formed of the same material and on the same layer as the scan line 121, the previous scan line 122, the light emission control line 123, the second gate electrode 125b, the third gate electrode 125c, the fifth gate electrode 125e, and the sixth gate electrode 125f, but is not limited thereto. The first storage capacitive plate 125a may be formed on a different layer through a different process.

The second storage capacitive plate 127 may be coupled to an adjacent pixel, and may be formed of the same material and on the same layer as the initialization voltage line 124.

The second transistor T2 includes a second semiconductor layer 131b, a second gate electrode 125b, a second source electrode 176b, and a second drain electrode 177b. The second source electrode 176b is a portion that projects from the data line 171, and the second drain electrode 177b corresponds to the second drain region 177b that is formed by doping an impurity in the second semiconductor layer 131b.

The third transistor T3 includes a third semiconductor layer 131c, a third gate electrode 125c, a third source electrode 176c, and a third drain electrode 177c. The third source electrode 176c corresponds to the third source region 176c that is formed by doping an impurity in the third semiconductor layer 131c, and the third drain electrode 177c corresponds to the third drain region 177c that is formed by doping an impurity in the third semiconductor layer 131c. The third gate electrode 125c may be formed as a separate dual-gate electrode 25 to prevent (or substantially prevent) the leakage current.

The fourth transistor T4 includes a fourth semiconductor layer 131d, a fourth gate electrode 125d, a fourth source electrode 176d, and a fourth drain electrode 177d. The fourth drain electrode 177d corresponds to the fourth drain region 177d that is formed by doping an impurity in the fourth semiconductor layer 131d. The fourth source electrode 176d is coupled to a fourth voltage line 124 through a fourth connection line 78. One end of the fourth connection line 78 is coupled to the fourth voltage line 124 through a contact hole 161 that is formed on the second gate insulating layer 142 and an interlayer insulating layer 160, and the other end of the fourth connection line 78 is coupled to the fourth source electrode 176d through the contact hole 161 that is formed on the gate insulating layer 141, the second gate insulating layer 142, and the interlayer insulating layer 160.

The fifth thin film transistor T5 includes a fifth semiconductor layer 131e, a fifth gate electrode 125e, a fifth source electrode 176e, and a fifth drain electrode 177e. The fifth source electrode 176e is one portion of the driving voltage line 172, and the fifth drain electrode 177e corresponds to the fifth drain region 177e that is formed by doping an impurity in the fifth semiconductor layer 131e.

The sixth thin film transistor T6 includes a sixth semiconductor layer 131f, a sixth gate electrode 125f, a sixth source electrode 176f, and a sixth drain electrode 177f. The sixth source electrode 176f corresponds to the sixth source region 176f that is formed by doping an impurity in the sixth semiconductor layer 131f.

One end of the driving semiconductor layer 131a of the first transistor T1 is coupled to the second semiconductor layer 131b and the third semiconductor layer 131c, and the other end of the first semiconductor layer 131a is coupled to the fifth semiconductor layer 131e and the sixth semiconductor layer 131f. Accordingly, the first source electrode 176a may be coupled to the second drain electrode 177b and the fifth drain electrode 177e, and the first drain electrode 177a may be coupled to the third source electrode 176c and the sixth source electrode 176f.

The first storage capacitive plate 125a of the storage capacitor Cst is coupled to the compensation drain electrode 177c and the initialization drain electrode 177d through a connection member 174. The connection member 174 is formed on the same layer as the data line 171. One end of the connection member 174 may be coupled to the compensation drain electrode 177c and the initialization drain electrode 177d through a contact hole that is formed on the first gate insulating layer 141, the second gate insulating layer 142, and the interlayer insulating layer 160, and the other end of the connection member 174 may be coupled to the first storage capacitive plate 125a through a contact hole 167 that is formed on the second gate insulating layer 142 and the interlayer insulating layer 160.

The second storage capacitive plate 127 of the storage capacitor Cst is coupled to a common voltage line 172 through a contact hole 168 that is formed on the interlayer insulating layer 160. On the other hand, the second transistor T2 is used as a switching device that selects a pixel intended to emit light. The second gate electrode 125b may be coupled to the scan line 121, the second source electrode 176b may be coupled to the data line 171, and the second drain electrode 177b may be coupled to the first transistor T1 and the fifth transistor TS.

Further, the sixth drain electrode 177f of the sixth transistor T6 may be directly coupled to a pixel electrode 191 of the organic light emitting diode 70 through a contact hole 181 that is formed on a protection layer 180.

The seventh transistor T7 may include a seventh semiconductor layer 131g, a seventh gate electrode 125g, a seventh source electrode 176g, and a seventh drain electrode 177g. The seventh source electrode 176g corresponds to the seventh drain region 177g that is formed by doping an impurity in the seventh semiconductor layer 131g, and the seventh drain electrode 177g corresponds to the seventh drain region 177g that is formed by doping an impurity in the seventh semiconductor layer 131g. The seventh source electrode 176g may be directly coupled to the sixth drain region 133f.

The seventh semiconductor layer 131g is formed on the same layer as the first semiconductor layer 131a, the second semiconductor layer 131b, and the sixth semiconductor layer 131f, and the first gate insulating layer 141 is formed on the seventh semiconductor layer 131g. The seventh gate electrode 125g that is a part of the seventh control line 128 may be formed on the first gate insulating layer 141, and the second gate insulating layer 142 may be formed on the seventh gate electrode 125g and the first gate insulating layer 141.

FIG. 6 is a cross-sectional view cut along the lines VIa-VIa′ and VIb-VIb′ of FIG. 5. The section a-a′ refers to the cross-sectional view along the line VIa-VIa′, and the section b-b′ refers to the cross-sectional view along the line VIb-VIb′.

Referring to the cross-sectional view cut along the line a-a′ of FIG. 6, a buffer layer 111 may be formed on a substrate 110. The substrate 110 may be formed of a suitable insulating substrate material, such as glass, quartz, ceramic, or plastic.

The seventh semiconductor layer 131g may be formed on the buffer layer 111, and the seventh semiconductor layer 131g may be electrically coupled to the seventh source electrode 176g and the seventh drain electrode 177g, which face each other, through a contact hole.

The first gate insulating layer 141 may be formed on the seventh semiconductor layer 131g and the buffer layer 111, and the first gate insulating layer 141 may be formed of a suitable insulating material such as silicon nitride (SiNx) or silicon oxide (SiO2).

The seventh gate electrode 125g, the initialization voltage line 124, and the initialization connection line 78 may be formed on the first gate insulating layer 141. The seventh gate electrode 125g may be a part of the black signal line, and may be formed to overlap the first channel region. The seventh gate electrode 125g may have an area formed by a first length L7a and a first width. The capacitance C7 of the seventh transistor T7 may be determined according to the area of the seventh gate electrode 125g. The initialization voltage line 124 may also be formed on the first gate insulating layer 141, may be formed on the same layer as the seventh gate electrode 125g, and may be made of the same material.

The second gate insulating layer 142 may be formed on the gate electrode 125g, the initialization voltage line 124, the initialization connection line 78, and the first gate insulating layer 141.

The seventh source electrode 176g and the seventh drain electrode 177g may be formed on the second gate insulating layer 142. The seventh drain electrode 177g may be electrically coupled to the initialization voltage line 177g through the contact hole to provide the initialization voltage VINT to the seventh source electrode 176g according to the black scan signal BS.

The protection layer 180 may be formed on the seventh source electrode 176g and the seventh drain electrode 177g.

An interception member, such as a black matrix, may be formed on the protection layer 180, but is not limited thereto.

Hereinafter, referring to the cross-sectional view cut along line b-b′ of FIG. 6, a difference between the structures of the sixth transistor and the seventh transistor will be described. The same reference numerals or configurations as those already explained with reference to line a-a′ of FIG. 6 will be omitted.

The sixth semiconductor layer 131f may be formed on the buffer layer 111, and the sixth semiconductor layer 131f may be electrically coupled to the sixth source electrode 176f and the sixth drain electrode 177f, which face each other, through a contact hole.

The sixth gate electrode 125f may be formed on the first gate insulating layer 141. The sixth gate electrode 125f may be a part of the light emission signal line 123, and may be formed to overlap the first channel region of the sixth semiconductor layer 131f. The sixth gate electrode 125f may have an area formed by a second length L6a and a second width (not illustrated). The capacitance C6 of the sixth transistor T6 may be determined according to the area of the sixth gate electrode 125f.

If it is assumed that the first width of the seventh gate electrode and the second width of the sixth gate electrode 125f are equal to each other, the area of the sixth gate electrode is larger than the area of the seventh gate electrode. Accordingly, the capacitance C6 of the sixth transistor T6 may be lower than the capacitance C7 of the seventh transistor T7.

The protection layer 180 may be formed on the sixth source electrode 176f and the sixth drain electrode 177f.

The organic light emitting diode 70 that includes the pixel electrode 191, the organic light emitting layer 271, and the common electrode 270 may be formed on the protection layer 180.

The pixel electrode 191 may be an anode that is a hole injection electrode, and the common electrode 270 may be a cathode that is an electron injection electrode, but are not limited thereto. Depending on the method for driving the organic light emitting display, the pixel electrode 191 may be a cathode, and the common electrode 270 may be an anode. Holes and electrons are injected from the pixel electrode 191 and the common electrode 270 into the organic light emitting layer 271, and light emission is performed when excitons in which injected holes and electrons are combined are shifted from an exited state to a ground state.

The organic light emitting layer 271 may be made of a low molecular organic material or a high molecular organic material, such as PEDOT (Poly 3,4-ethylenedioxythiophene). Further, the organic light emitting layer 271 may be formed of a multilayer including at least one of a light emitting layer, a hole injection layer (HIL), a hole transporting layer (HTL), an electron transporting layer (ETL), and an electron injection layer (EIL). If the organic light emitting layer 271 includes all the above-described layers, the hole injection layer may be arranged on the pixel electrode 191 on which the hole injection layer is an anode, and then the hole transporting layer, the light emitting layer, the electron transporting layer, and the electron injection layer may be laminated in order on the hole injection layer. Because the common electrode 270 is formed of a reflective conduction material, a bottom emission type organic light emitting display may be provided.

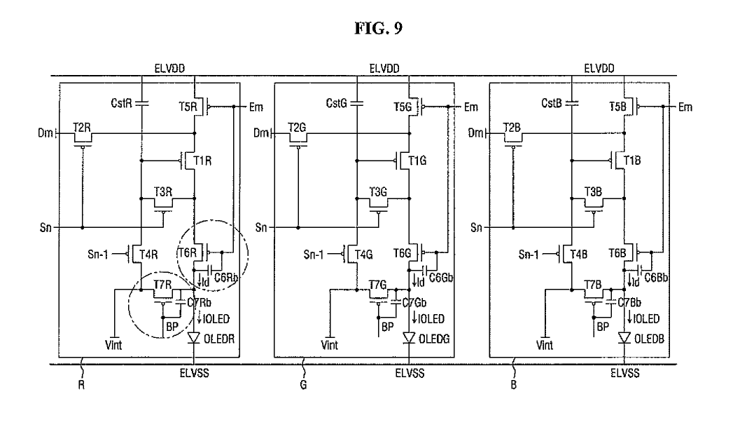

FIG. 9 is an equivalent circuit diagram of RGB pixels of a display device according to another embodiment of the present invention.

Referring to FIG. 9, a pixel of a display device according to another embodiment of the present invention may include a first sub-pixel, a second sub-pixel, and a third sub-pixel. The first sub-pixel may be, for example, an R pixel on which red video data is displayed. The second sub-pixel may be, for example, a G pixel on which green video data is displayed. The third sub-pixel may be, for example, a B pixel on which blue video data is displayed. FIG. 9 illustrates that the display device includes three sub-pixels, but is not limited thereto. The display device may include a plurality of sub-pixels, and the first to third sub-pixels may be pixels that display video data having different colors.

In this embodiment, the first sub-pixel, for example, R pixel, may include a light emitting diode OLED_R of the first sub-pixel that is coupled between a first node N1 and a terminal of the second power voltage ELVSS, a seventh transistor T7Ra that turns off the light emitting diode OLED_B of the first sub-pixel through lowering of the voltage of the first node below the second power voltage ELVSS, and a sixth transistor T6Rb that provides a first driving current Id_Rb to the first node N1 and turns on the light emitting diode OLED_R of the second sub-pixel by increasing the voltage of the first node N1 above the second power voltage ELVSS.

The capacitance Coled_R of the light emitting diode OLED_R of the first sub-pixel may be different from the capacitance Coled_G of the light emitting diode OLED_G of the second sub-pixel, and the capacitance Coled_G of the light emitting diode OLED_G of the second sub-pixel may be higher than the capacitance Coled_R of the light emitting diode OLED_R of the first sub-pixel.

The gate electrode of the sixth transistor T6R of the first sub-pixel may receive the light emission signal Em, and the source electrode of the sixth transistor T6 of the first sub-pixel may be coupled to the drain electrode of the first transistor T1 R and the source electrode of the third transistor T3R of the first sub-pixel. The drain electrode of the sixth transistor T6Rb of the first sub-pixel may be electrically coupled to the anode of the fight emitting diode OLED_R of the first sub-pixel. The fifth transistor T5R and the sixth transistor T6Rb of the first sub-pixel are simultaneously turned on according to the light emission signal that is transferred through the light emission control line to transfer the first power voltage ELVDD to the light emitting diode OLED_R, and the driving current Id_R of the first sub-pixel flows to the light emitting diode OLED_R. The sixth transistor T6Rb may have capacitance C6Rb.

The gate electrode of the seventh transistor T7Rb of the first sub-pixel is coupled to the black signal line 124 (in FIG. 5), and the source electrode of the seventh transistor T7R of the first sub-pixel is coupled to the drain electrode of the sixth transistor T6Rb of the first sub-pixel and the anode of the light emitting diode OLED_R. The drain electrode of the seventh transistor T7Rb of the first sub-pixel is coupled to the initialization voltage V1NT and the source electrode of the fourth transistor T4R of the first sub-pixel. The seventh transistor of the first sub-pixel may have capacitance C7Rb.

The capacitance C6Rb of the sixth transistor of the first sub-pixel and the capacitance C7Rb of the seventh transistor T7R of the first sub-pixel may differ depending on the area of the gate electrode of the sixth transistor T6Rb of the first sub-pixel and the area of the gate electrode of the seventh transistor T7Rb of the first sub-pixel. The capacitance of the transistor is in reverse proportion to the area of the transistor. Further, the area of the gate electrode means the area of the gate electrode, but is not limited thereto. The area of the gate electrode may mean the overlapping area between the gate electrode and the drain electrode or between the gate electrode and the source electrode.

Because the configuration of the first sub-pixel is substantially the same as the configuration of the second sub-pixel as described above with reference to FIGS. 3 to 5, some repetitive explanation thereof will be omitted.

The configuration of an organic light emitting display according to the present invention may not be limited to the circuit of the organic light emitting display illustrated in FIG. 9 according to some embodiments of the present invention.

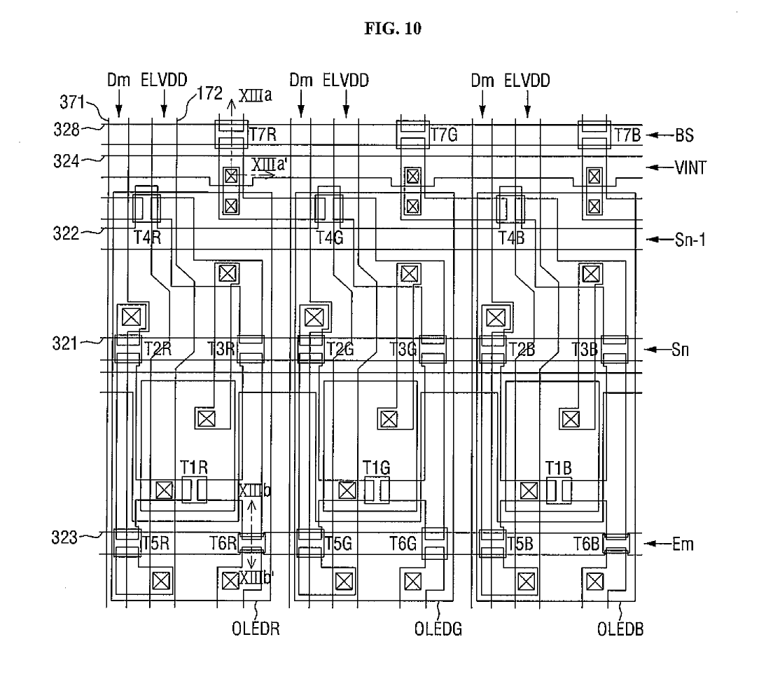

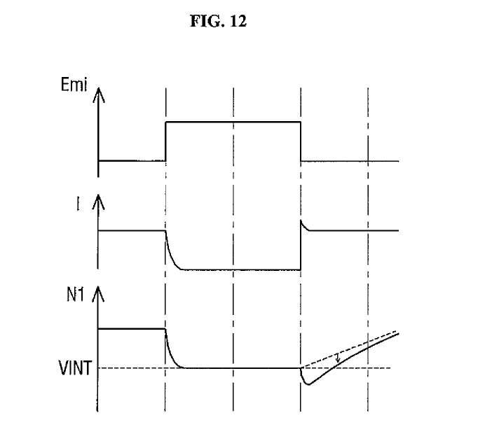

FIG. 10 is a layout diagram schematically illustrating positions of thin film transistors and capacitors of RGB pixels of a display device according to another embodiment of the present invention. FIG. 12 is a graph illustrating level changes of current and voltage applied to light emitting diodes of a display device according to another embodiment of the present invention.

Because the configuration illustrated in FIG. 10 is similar to the configuration of the pixel of FIG. 4 and the graph of FIG. 12 is similar to the graph of FIG. 8, some repeated explanation of elements having the same reference numerals, configuration, and operation will be omitted.

Referring to FIG. 10, a first transistor T3R of a first sub-electrode, a second transistor T2R of the first sub-electrode, a third transistor T3R of the first sub-electrode, a fourth transistor T4R of the first sub-electrode, a fifth transistor T5R of the first sub-electrode, a sixth transistor T6R of the first sub-electrode, and a seventh transistor T7R of the first sub-electrode may be formed along a semiconductor layer 131 (in FIG. 5).

FIG. 10 illustrates that the area of the sixth gate electrode of the first sub-electrode that is formed on the sixth transistor T6R of the first sub-electrode is smaller than the area of the sixth gate electrode of the second sub-pixel and the third sub-pixel formed on the sixth transistors T6G and T6B of the second sub-pixel and the third sub-pixel, and is smaller than the gate electrode areas of other transistors T1R, T2R, T3R, T4R, T5R, and T7R of the first sub-electrode. Because the area of the gate electrode of the transistor is in reverse portion to the internal capacitance of the transistor, the capacitance C6Rb of the sixth transistor of the first sub-electrode may be higher than the capacitance C7Rb of the seventh transistor of the first sub-electrode. In FIG. 10, the area of the gate electrode of the sixth transistor T6G of the first sub-pixel is modified. However, the modification of the area of the gate electrode is not limited thereto, and all the areas of the gate electrodes of the seventh transistor T7G, the sixth transistor T6G, and the seventh transistor T7G of the second sub-pixel may be modified.

Because the internal capacitance Coled_R of the light emitting diode OLED_R of the first sub-pixel is lower than the internal capacitance Coled_G of the light emitting diode of the second sub-pixel, the light emitting diode OLED_R of the first sub-pixel may be turned on faster than the turn-on of the light emitting diode OLED_G of the second sub-pixel.

However, because the internal capacitance Coled_R of the light emitting diode OLED_R of the first sub-pixel is lower than the internal capacitance Coled_G of the light emitting diode of the second sub-pixel and is greatly affected by the leakage current that may occur in the first sub-pixel, the black image may not be displayed even if the initialization voltage VINT is applied. Accordingly, in order to display a color that corresponds to the black data, the initialization voltage VINT may be lowered. However, because it may cause a problem in manufacturing to lower only the initialization voltage VINT that is applied to the first sub-pixel, the coupling phenomenon of the internal capacitance of the light emitting diode OLED_R of the first sub-pixel, the sixth transistor T6Rb of the first sub-pixel, and the seventh transistor T7Rb of the first sub-pixel may be used.

Hereinafter, referring to FIG. 12, the coupling phenomenon that is generated in the light emitting diode OLED_R of the first sub-pixel will be described in detail.

At the moment when the light emission signal Emi falls again to a low level after a time (e.g., a predetermined time) elapses from the rising of the light emission signal Emi to a high level, the seventh transistor T7G of the first sub-pixel is turned off, and the initialization voltage VINT is not provided to the first node N1 anymore. The sixth transistor T6G is turned on by the light emission signal Emi to apply the driving current Id_G to the first node N1, and the driving current, of which the level is equal to or higher than the level of the light emission absolute potential of the light emitting diode OLED_R, is provided to the first node N1. However, coupling may occur due to the internal capacitance of the light emitting diode OLED_R, the sixth transistor, and the seventh transistor. At the moment when the coupling occurs, the level of the current I abruptly rises, but falls soon to a stable level. The voltage of the first node N1 at the moment when the coupling occurs may rise or fall by the capacitance C6Rb of the sixth transistor and the capacitance C7Rb of the seventh transistor of the first sub-electrode. The voltage level of the first node N1 can be calculated to follow Equation 2 below.

$$VN 1 = \frac{1}{Coled} {\int }_{0}^{1 H} ileak ( t ) d t + VINT + ( \frac{0.5 {C}_{7}}{Coled + 0.5 {C}_{7}} - \frac{0.5 {C}_{6}}{Coled + 0.5 {C}_{6}} ) \times ( VGH - VGL ) \qquad Equation 2$$

The last item of Equation 1 means the voltage of the first node N1 that is coupled by the internal capacitance of the light emitting diode, the sixth transistor, and the seventh transistor. The voltage change due to the coupling may have a positive value or a negative value depending on the levels of the capacitance C6 of the sixth transistor and the capacitance C7 of the seventh transistor.

In arrangement of Equation 1, if the level of the capacitance C7 of the seventh transistor is lower than the level of the capacitance C6 of the sixth transistor, the last term of Equation 1 has a negative value, and thus the voltage of the first node N1 can be lowered. Accordingly, it becomes possible to secure the voltage of the first node N1 that is lower than the light emission absolute potential of the light emitting diode OLED without adjusting the value of the initialization voltage VINT. The light emission absolute potential of the light emitting diode OLED means a voltage that is obtained by summing the second power voltage ELVSS and the threshold voltage of the light emitting diode OLED.

Referring again to FIG. 12, if the voltage level of the second node N2 becomes lower than the initialization voltage VINT by the coupling, and thus an image that corresponds to the black data can be stably displayed.

Referring again to FIG. 10, the area of the gate electrode of the sixth transistor of the first sub-pixel is smaller than the area of the gate electrode of the seventh transistor of the first sub-pixel. Accordingly, the capacitance C6Rb of the sixth transistor of the first sub-pixel may be lower than the capacitance C7Rb of the seventh transistor of the first sub-pixel. However, the area of the gate electrode means the area of the gate electrode, but is not limited thereto. The area of the gate electrode may mean the overlapping area between the gate electrode and the drain electrode or between the gate electrode and the source electrode.

Further, the area of the gate electrode of the sixth transistor T6R of the first sub-pixel is modified, but is not limited thereto. All the gate electrode areas of the seventh transistor T7R, the sixth transistor T6R, and the seventh transistor T7R of the first sub-pixel may be modified.

According to some embodiments of the present invention, a black-luminance image may be displayed through the light emitting diode OLED_R of the first sub-pixel.

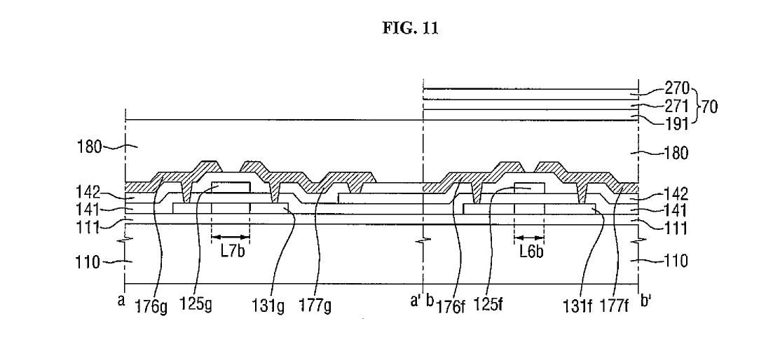

FIG. 11 is a cross-sectional view cut along lines XIIIa-XIIIa′ and XIIIb-XIIIb′ of FIG. 10. The section a-a′ and b-b′ refer to the cross-sections of the lines XIIIa-XIIIa′ and XIIIb-XIIIb′, respectively, of FIG. 10.

Referring to FIG. 11, the sixth semiconductor layer 131f may be formed on the buffer layer 111, and the sixth semiconductor layer 131f may be electrically coupled to the sixth source electrode 176f and the sixth drain electrode 177f, which face each other, through a contact hole.

The sixth gate electrode 125f may be formed on the first gate insulating layer 141. The sixth gate electrode 125f may have an area that is formed by a third length L6b and a third width. The capacitance C6 of the sixth transistor T6 may be determined according to the area of the sixth gate electrode 125f.

That is, if it is assumed that the third width of the seventh gate electrode is equal to the fourth width of the sixth gate electrode 125f, the area of the sixth gate electrode is smaller than the area of the seventh gate electrode. Accordingly, the capacitance C6 of the sixth transistor T6 may be higher than the capacitance C7 of the seventh transistor T7.

Because the configuration illustrated in FIG. 11 is substantially the same as the configuration as described above with reference to FIG. 6, the explanation thereof will be omitted.

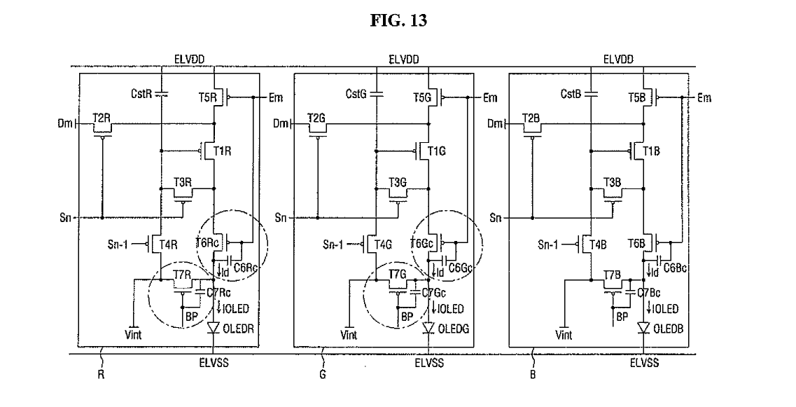

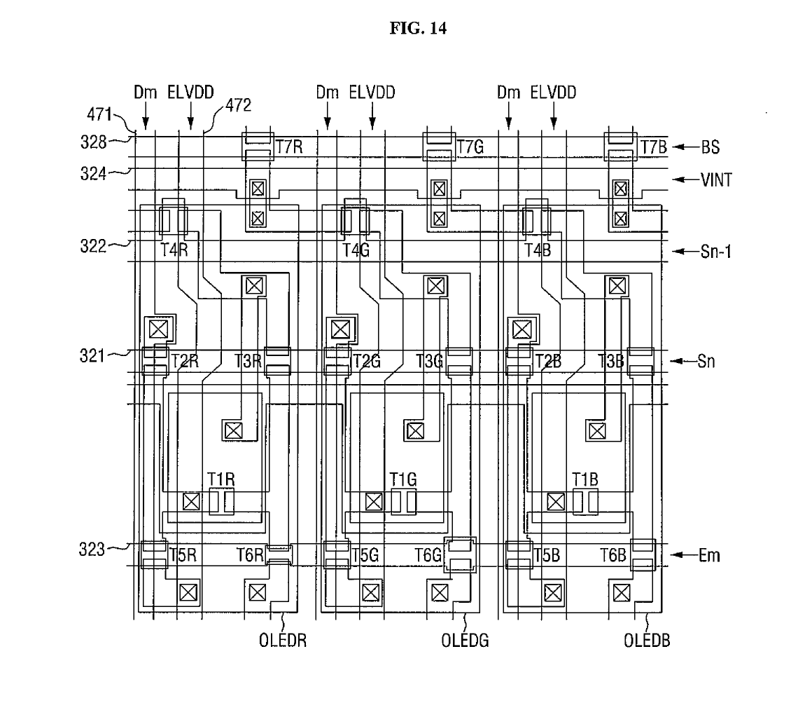

FIG. 13 is an equivalent circuit diagram of RGB pixels of a display device according to still another embodiment of the present invention, and FIG. 14 is a layout diagram schematically illustrating positions of thin film transistors and capacitors of RGB pixels of a display device according to another embodiment of the present invention.

Referring to FIG. 13, the sizes of the sixth transistor and the seventh transistor of the first sub-electrode may be modified. Further, the sizes of the sixth transistor of the second sub-electrode and the seventh transistor of the first sub-electrode may be modified.

The configuration of an organic light emitting display according to the present invention may not be limited to the circuit of the organic light emitting display illustrated in FIG. 13 according to still another embodiment of the present invention.

Referring to FIG. 14, areas of the sixth gate electrodes of the first to third sub-electrodes may be different from each other. That is, FIG. 14 illustrates that the sixth gate electrode T6Rc of the sixth transistor of the first sub-electrode has the smallest area, the sixth gate electrode T6Gc of the sixth transistor of the second sub-electrode has the largest area, and the sixth gate electrode T6Bc of the sixth transistor of the third sub-electrode has a middle area. Because the area of the gate electrode of the transistor is in reverse proportion to the internal capacitance of the transistor, the size of the capacitance becomes larger in the order of the capacitance C6Gc of the sixth transistor of the second sub-electrode, the capacitance C6Be of the sixth transistor of the third sub-electrode, and the capacitance C6Rc of the sixth transistor of the first sub-electrode.

The area of the gate electrode of the transistor means the area of the gate electrode, but is not limited thereto. The area of the gate electrode of the transistor may mean the overlapping area between the gate electrode and the drain electrode or between the gate electrode and the source electrode.

Further, the areas of the gate electrodes of the sixth transistors T6G of the first sub-pixel and the second sub-pixel are modified, but are not limited thereto. All the gate electrode areas of the seventh transistor T7G, the sixth transistor T6G, and the seventh transistor T7G of the first sub-pixel and the second sub-pixel may be modified.

Because the configuration of the first to third sub-pixels is substantially the same as the configuration illustrated in FIGS. 3 to 5 having the same reference numerals, the explanation thereof will be omitted.

According to still another embodiment of the present invention, the color change at low gradation of the light emitting diode OLED_G of the second sub-pixel can be prevented, and the black-luminance image can be displayed through the light emitting diode OLED_R of the first sub-pixel.

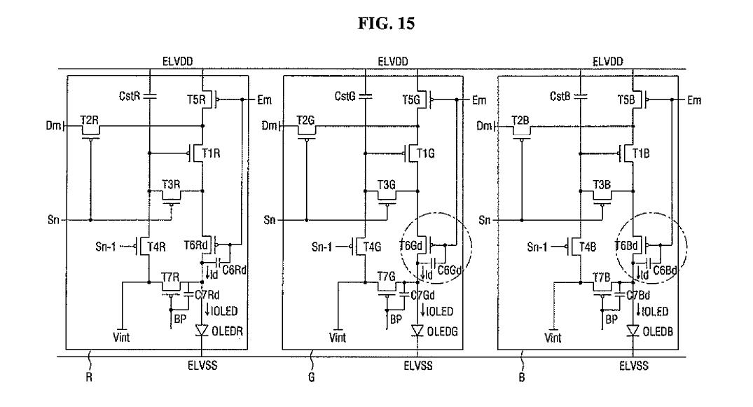

FIG. 15 is an equivalent circuit diagram of RGB pixels of a display device according to still another embodiment of the present invention, and FIG. 14 is a layout diagram schematically illustrating positions of thin film transistors and capacitors of RGB pixels of a display device according to another embodiment of the present invention.

Referring to FIG. 15, the sizes of the sixth transistor and the seventh transistor of the first sub-electrode may be modified. Further, the sizes of the sixth transistor and the seventh transistor of the third sub-electrode may be modified.

The configuration of an organic light emitting display according to the present invention may not be limited to the circuit of the organic light emitting display illustrated in FIG. 15 according to still another embodiment of the present invention.

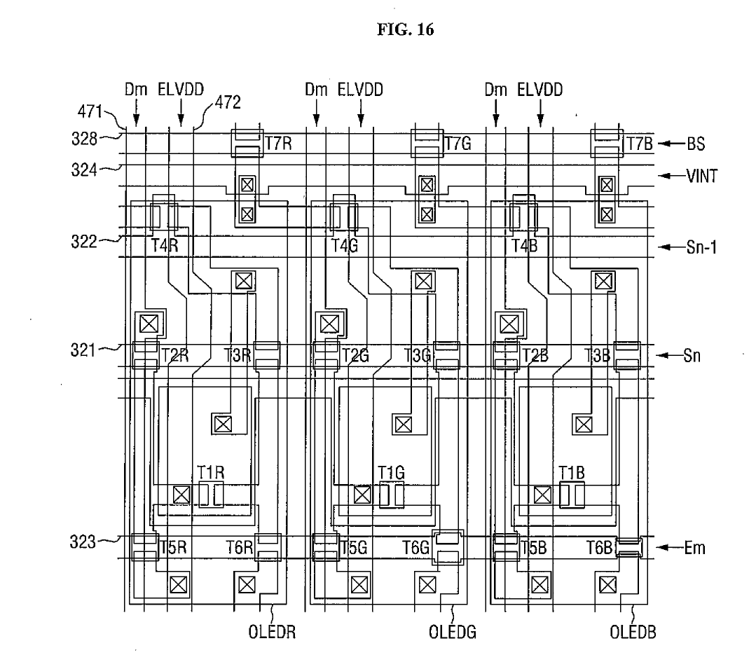

Referring to FIG. 16, areas of the sixth gate electrodes of the first to third sub-electrodes may be different from each other. That is, FIG. 16 illustrates that the sixth gate electrode T6Bc of the sixth transistor of the third sub-electrode has the smallest area, the sixth gate electrode T6Ge of the sixth transistor of the second sub-electrode has the largest area, and the sixth gate electrode T6Rc of the sixth transistor of the first sub-electrode has a middle area. Because the area of the gate electrode of the transistor is in reverse proportion to the internal capacitance of the transistor, the size of the capacitance becomes larger in the order of the capacitance C6Gc of the sixth transistor of the second sub-electrode, the capacitance C6Re of the sixth transistor of the first sub-electrode, and the capacitance C6Bc of the sixth transistor of the third sub-electrode.

The area of the gate electrode of the transistor may include the area of the gate electrode, but is not limited thereto. The area of the gate electrode of the transistor may further include the overlapping area between the gate electrode and the drain electrode or between the gate electrode and the source electrode.

Further, it is described that the areas of the gate electrodes of the sixth transistors T6G and T6B of the second sub-pixel and the third sub-pixel are modified. However, modification of the gate electrode areas is not limited thereto, and all the gate electrode areas of the seventh transistors T7G and T7B, the sixth transistor T6G and T6B, and the seventh transistor T7G and T7B of the second sub-pixel and the third sub-pixel may be modified.

Because the configuration of the first to third sub-pixels is substantially the same as the configuration illustrated in FIGS. 3 to 5 having the same reference numerals, some repetitive explanation thereof will be omitted.

According to still another embodiment of the present invention, the color change at low gradation of the light emitting diode OLED_G of the second sub-pixel may be prevented, and the black-luminance image can be displayed through the light emitting diode OLED_R of the third sub-pixel.

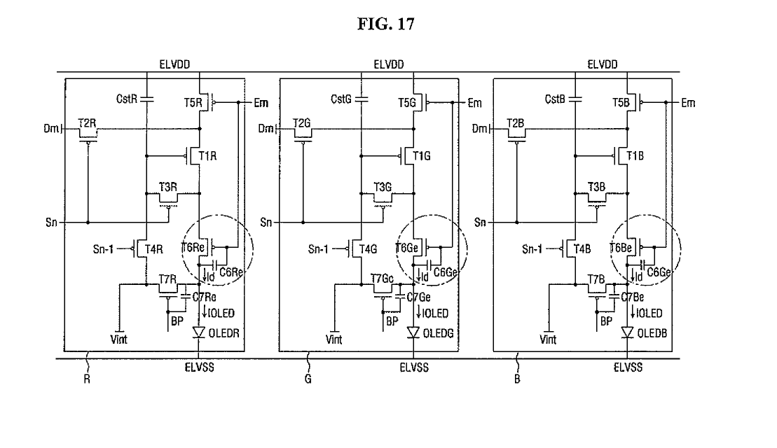

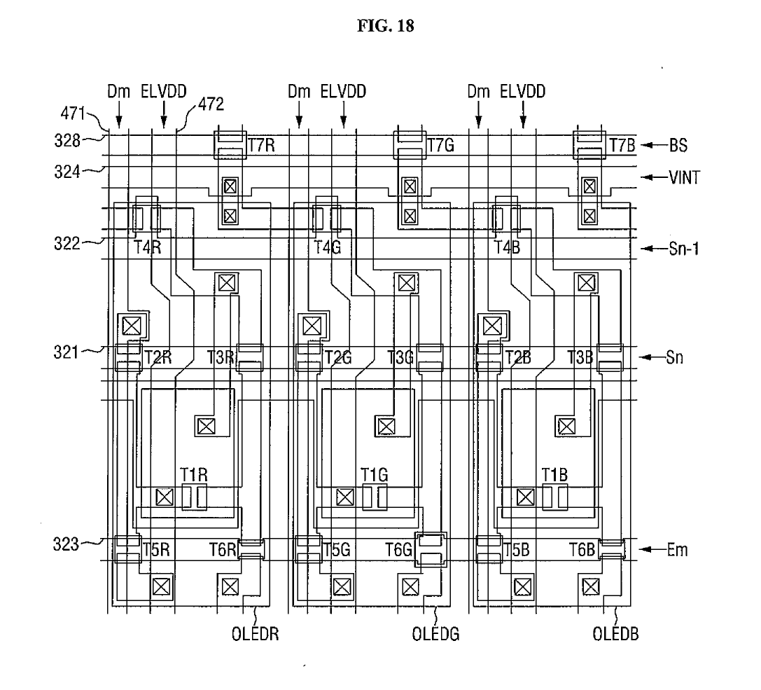

FIG. 17 is an equivalent circuit diagram of RGB pixels of a display device according to still another embodiment of the present invention, and FIG. 18 is a layout diagram schematically illustrating positions of thin film transistors and capacitors of RGB pixels of a display device according to another embodiment of the present invention.

Referring to FIG. 17, the sizes of the sixth transistor and the seventh transistor of the first sub-electrode may be modified. Further, the sizes of the sixth transistor of the second sub-electrode and the seventh transistor of the second sub-electrode electrode may be modified. Further, the sizes of the sixth transistor of the second sub-electrode and the seventh transistor of the second sub-electrode may be modified.

The configuration of an organic light emitting display according to the present invention may not be limited to the circuit of the organic light emitting display illustrated in FIG. 17 according to still another embodiment of the present invention.

Referring to FIG. 18, the area of the sixth gate electrodes of the second sub-electrode may be different from the area of the sixth gate electrode of the first sub-electrode or the third sub-electrode. That is, FIG. 18 illustrates that the area of the sixth gate electrode T6Re of the sixth transistor of the first sub-electrode is substantially equal to the area of the sixth gate electrode T6Re of the sixth transistor of the first sub-electrode, and the area of the sixth gate electrode T6Ge of the sixth transistor of the second sub-electrode is larger than the area of the sixth gate electrode of any other sub-pixel. Because the area of the gate electrode of the transistor is in reverse proportion to the internal capacitance of the transistor, the capacitance C6Ge of the sixth transistor of the second sub-electrode is the smallest, and the capacitance C6Re of the sixth transistor of the first sub-electrode is substantially equal to the capacitance C6Be of the sixth transistor of the third sub-electrode.

The area of the gate electrode of the transistor includes the area of the gate electrode, but is not limited thereto. The area of the gate electrode of the transistor may further include the overlapping area between the gate electrode and the drain electrode or between the gate electrode and the source electrode.

Further, it is described that the areas of the gate electrodes of the sixth transistors T6 of the first to third sub-pixels are modified. However, the modification of the gate electrode areas is not limited thereto, and all the gate electrode areas of the seventh transistors T7 of the first to third sub-pixels, or all the gate electrode areas of the sixth transistors T6 of the first to third sub-pixels and the seventh transistors T7 of the first to third sub-pixels may be modified.

Because the configuration of the first to third sub-pixels is substantially the same as the configuration illustrated in FIGS. 3 to 5 having the same reference numerals, some repetitive explanation thereof will be omitted.

According to still another embodiment of the present invention, the color change at low gradation of the light emitting diode OLED_G of the second sub-pixel may be prevented (or substantially prevented), and the black-luminance image may be displayed through the light emitting diodes OLED_R and OLED_B of the first and third sub-pixels.

However, the characteristics of the present invention are not restricted to those set forth herein. The above and other characteristics of the present invention will become more apparent to one of ordinary skill in the art to which the present invention pertains by referencing the claims, and their equivalents.

While the present invention has been particularly shown and described with reference to example embodiments thereof, it will be understood by those of ordinary skill in the art that various changes in form and details may be made therein without departing from the spirit and scope of the present invention as defined by the following claims, and their equivalents. It is therefore desired that the present embodiments be considered in all respects as illustrative and not restrictive, reference being made to the appended claims and their equivalents rather than the foregoing description to indicate the scope of the invention.

What is claimed is:

1. A display device comprising:
a pixel comprising a first sub-pixel and a second sub-pixel, wherein the first sub-pixel comprises:
a first light emitting diode coupled between a first node and a second node;
a first transistor configured to turn off the first light emitting diode by lowering a voltage of the first node below a voltage of the second node by providing a first initialization voltage to the first node; and
a second transistor configured to turn on the first light emitting diode by increasing the voltage of the first node above the voltage of the second node by providing a first driving current to the first node,
wherein the second sub-pixel comprises a second light emitting diode,
wherein a capacitance of the first light emitting diode is higher than a capacitance of the second light emitting diode, and
an area of a gate electrode of the first transistor is smaller than an area of a gate electrode of the second transistor.

2. The display device of claim 1, wherein a capacitance of the first transistor is higher than a capacitance of the second transistor.

3. The display device of claim 1, wherein the area of the gate electrode of the first transistor comprises a region where an electrode of the first transistor that is coupled to the first node and the gate electrode of the first transistor overlap each other, and
the area of the gate electrode of the second transistor comprises a region where an electrode of the second transistor that is coupled to the first node and the gate electrode of the second transistor overlap each other.

4. The display device of claim 1, wherein the first transistor is configured to turn off the first light emitting diode by providing the first initialization voltage to the first node in response to a black scan signal, and
the second transistor is configured to turn on the first light emitting diode by providing the first driving current to the first node in response to a light emission signal.

5. The display device of claim 4, wherein the light emission signal and the black scan signal have phases opposite to each other.

6. The display device of claim 1, wherein the second sub-pixel comprises:
the second light emitting diode coupled between a third node and a fourth node;
a third transistor configured to turn off the second light emitting diode by lowering a voltage of the third node below a voltage of the fourth node by providing a second initialization voltage to the third node; and
a fourth transistor configured to turn on the second light emitting diode by increasing the voltage of the third node above the voltage of the fourth node by providing a second driving current to the third node.

7. The display device of claim 6, wherein a level of the first initialization voltage is equal to a level of the second initialization voltage.

8. The display device of claim 6, wherein a capacitance of the third transistor is substantially equal to a capacitance of the fourth transistor.

9. A display device comprising:
a pixel comprising a first sub-pixel and a second sub-pixel,
wherein the first sub-pixel comprises:
a first light emitting diode coupled between a first node and a second node;
a first transistor configured to turn off the first light emitting diode by lowering a voltage of the first node below a voltage of the second node by providing of a first initialization voltage to the first node; and
a second transistor configured to turn on the first light emitting diode by increasing the voltage of the first node above the voltage of the second node through by providing a first driving current to the first node,
wherein the second sub-pixel comprises a second light emitting diode,
wherein a capacitance of the first light emitting diode is lower than a capacitance of the second light emitting diode, and
wherein an area of a gate electrode of the first transistor is larger than an area of a gate electrode of the second transistor.

10. The display device of claim 9, wherein a capacitance of the first transistor is lower than a capacitance of the second transistor.

11. The display device of claim 9, wherein the area of the gate electrode of the first transistor comprises a region where an electrode of the first transistor that is coupled to the first node and the gate electrode of the first transistor overlap each other, and
wherein the area of the gate electrode of the second transistor comprises a region where an electrode of the second transistor that is coupled to the first node and the gate electrode of the second transistor overlap each other.

12. The display device of claim 9, wherein the first transistor is configured to turn off the first light emitting diode by providing the first initialization voltage to the first node in response to a black scan signal, and
wherein the second transistor is configured to turn on the first light emitting diode by providing the first driving current to the first node in response to a light emission signal.

13. The display device of claim 12, wherein the light emission signal and the black scan signal have phases opposite to each other.

14. The display device of claim 9, wherein the second sub-pixel comprises:
the second light emitting diode coupled between a third node and a fourth node;
a third transistor configured to turn off the second light emitting diode by lowering a voltage of the third node below a voltage of the fourth node by providing a second initialization voltage to the third node; and
a fourth transistor configured to turn on the second light emitting diode by increasing the voltage of the third node above the voltage of the fourth node by providing a second driving current to the third node.

15. The display device of claim 14, wherein a level of the first initialization voltage is equal to a level of the second initialization voltage.

16. The display device of claim 14, wherein a capacitance of the third transistor is substantially equal to a capacitance of the fourth transistor.

17. A display device comprising:
a pixel comprising a first sub-pixel and a second sub-pixel,
wherein the first sub-pixel comprises:
a first light emitting diode coupled between a first node and a second node;
a first transistor configured to turn off the first light emitting diode by lowering a voltage of the first node below a voltage of the second node by providing a first initialization voltage to the first node; and
a second transistor configured to turn on the first light emitting diode by increasing the voltage of the first node above the voltage of the second node by providing a first driving current to the first node,
wherein the second sub-pixel comprises:
a second light emitting diode coupled between a third node and a fourth node;
a third transistor configured to turn off the second light emitting diode by lowering a voltage of the third node below a voltage of the fourth node by providing of a second initialization voltage to the third node; and
a fourth transistor configured to turn on the second light emitting diode by increasing the voltage of the third node above the voltage of the fourth node by providing a second driving current to the third node,
wherein a capacitance of the first light emitting diode is higher than a capacitance of the second light emitting diode,
wherein an area of a gate electrode of the first transistor is smaller than an area of a gate electrode of the second transistor, and
wherein an area of a gate electrode of the third transistor is larger than an area of a gate electrode of the fourth transistor.

18. The display device of claim 17, wherein a capacitance of the first transistor is higher than a capacitance of the second transistor, and a capacitance of the third transistor is lower than a capacitance of the fourth transistor.

19. The display device of claim 17, wherein the area of the gate electrode of the first transistor comprises a region where an electrode of the first transistor that is coupled to the first node and the gate electrode of the first transistor overlap each other,
wherein the area of the gate electrode of the second transistor comprises a region where an electrode of the second transistor that is coupled to the first node and the gate electrode of the second transistor overlap each other,
wherein the area of the gate electrode of the third transistor comprises a region where an electrode of the third transistor that is coupled to the second node and the gate electrode of the third transistor overlap each other, and
wherein the area of the gate electrode of the fourth transistor comprises an area of a region where an electrode of the fourth transistor that is coupled to the second node and the gate electrode of the fourth transistor overlap each other.

20. The display device of claim 17, wherein a level of the first initialization voltage is equal to a level of the second initialization voltage.
